(19) United States
(12) Patent Application Publication
(10) Pub. No.: US 2019/0383721 A1
(43) Pub. Date: Dec. 19, 2019

(54) EXHAUST GAS PARTICULATE MATTER SENSOR

(71) Applicant: SEJONG IND. CO., LTD., Ulsan (KR)

(72) Inventors: Jae-Hyeon EOM, Yongin-si (KR); Ji-Sang JANG, Yongin-si (KR); Ho-Cheol SUH, Yongin-si (KR)

(21) Appl. No.: 16/434,225

(22) Filed: Jun. 7, 2019

(30) Foreign Application Priority Data
Jun. 15, 2018 (KR) 10-2018-0068958

(51) Int. Cl. G01N 15/06; G01N 15/10; G01N 15/02; F01N 11/00; F02D 41/22

(52) U.S. Cl. CPC G01N 15/0656; G01N 15/10; G01N 15/02; G01N 27/60; G01N 15/0606; F02D 41/222; F01N 11/00

(57) ABSTRACT

Disclosed is an exhaust gas particulate matter (PM) sensor. According to an embodiment of the present invention, there is provided an exhaust gas particulate matter (PM) sensor that is provided on an exhaust line through which exhaust gas from a vehicle passes and is provided with an electrode formed to detect PM, the PM sensor including: a first insulating layer; a PM detection electrode placed under the first insulating layer; a temperature compensation electrode placed in parallel with the PM detection electrode; a second insulating layer placed under the PM detection electrode and the temperature compensation electrode; a heater electrode placed under the second insulating layer; and a third insulating layer placed under the heater electrode.

### CROSS REFERENCE TO RELATED APPLICATION(S)

This application claims the benefit of Korean Patent Application No. 10-2018-0068958, filed Jun. 15, 2018, which is hereby incorporated by reference in its entirety into this application.

### BACKGROUND OF THE INVENTION

### 1. Technical Field

The present invention relates generally to an exhaust gas particulate matter (PM) sensor. More particularly, the present invention relates to particulate matter (PM) sensing in which it is possible to correct an exhaust gas particulate matter (PM) sensor that considers resistance change caused by change in temperature and deposition of PM.

### 2. Description of the Related Art

In general, as emission regulation is tightened, there is a growing interest in a post-treatment apparatus for cleaning exhaust gas. In particular, regulations on particulate matter (PM) from a diesel vehicle are becoming stricter.

In general, a gasoline-fuelled vehicle or a diesel-fuelled vehicle emits exhaust gas that contains carbon monoxide, hydrocarbons, nitrogen oxide (NOx), sulfur oxides, and particulate matter.

Here, in the exhaust gas containing carbon monoxide, hydrocarbons, nitrogen oxide (NOx), sulfur oxides, particulate matter, and the like emitted from the vehicle, particulate matter is known to be a major cause of air pollution because particulate matter increases generation of suspended particles.

Due to demands for a pleasant environment and environmental regulations of each country against air pollutants described above, regulations of exhaust pollutants contained in exhaust gas have increased gradually, and as a measure for this, various exhaust gas filtration methods have been studied.

That is, engine technologies, pre-treatment technologies, and the like have been developed as a technology of reducing pollutants inside the vehicle engine itself in order to reduce air pollutants contained in exhaust gas. However, as the regulation of exhaust gas is tightened, there is a limit in satisfying the regulations using only the technology of reducing harmful gas inside the engine.

In order to solve this problem, a post-treatment technology in which exhaust gas emitted after combustion in the vehicle engine is processed has been proposed, and examples of the post-treatment technology include apparatuses for reducing exhaust gas through an oxidation catalyst, a nitrogen oxide catalyst, an exhaust filter, and the like.

Among the oxidation catalyst, the nitrogen oxide catalyst, and the exhaust filter as described above, the most efficient and practical technology for reducing particulate matter is the apparatus for reducing exhaust gas by using the exhaust filter.

This apparatus for reducing exhaust gas is a technology in which particulate matter emitted usually from a diesel engine is captured by a filter, then the result is burnt (hereinafter, referred to as regeneration) and particulate matter is captured again to repeat the process, which is excellent in terms of performance. However, it is difficult to accurately measure the amount and the size of particulate matter, so durability and economic efficiency are obstacles to commercialization, especially when a measurement value of a PM sensor is inaccurate due to change in exhaust gas temperature and deposition of particulate matter and no temperature correction is not provided.

### SUMMARY OF THE INVENTION

Embodiments of the present invention are to overcome the problems occurring in the related art. In order to eliminate particulate matter from a diesel vehicle, it is mandatory to equip a diesel particulate filter (DPF), and in order to monitor an emission of particulate matter according to malfunction of the DPF, it is mandatory (Euro 6C) to equip an On Board Diagnostics (OBD) particulate matter sensor at the rear end of the DPF so as to measure the amount of particulate matter. Currently, a particulate matter sensor equipped in a diesel vehicle uses a method of measuring resistance change caused by deposition of particulate matter in an interdigital electrode. A current cannot flow when particulate matter is not deposited. A circuit where a current is able to flow by deposited particulate matter is formed, and the amount of deposited particulate matter is determined by the amount of particulate matter in exhaust gas. Therefore, it is possible to measure the amount of particulate matter in exhaust gas by measuring the resistance change. When a predetermined amount of particulate matter or more is deposited, continuous particulate matter monitoring is possible through a regeneration step where a heater is used to combust deposited particulate matter for elimination.

Currently, the particulate matter sensor is manufactured using a method where an interdigital electrode is formed using a metal such as Pt that has high-temperature stability on a ceramic substrate such as Al₂O₃, and the like. The width of the electrode and the spacing between electrodes are several tens μm. Factors, such as the shape of deposited particulate matter, which affect the performance of the sensor, are determined by the pattern of the electrode. However, such a particulate matter sensor has a problem that it is impossible to measure the number of particles (PN) and the sensor is greatly influenced by metal particles in exhaust gas.

With respect to EURO 6, current exhaust gas regulations on particulate matter restrict the total amount of particulate matter and the number of particles (PN) for a diesel vehicle, and OBD regulations restrict only the total amount of particulate matter. Considering that the smaller the particle size, the greater the harmful influence on a human body and that the size of particulate matter is very small in the case of a Gasoline Direct Injection (GDI) engine, it is expected that future regulation targets will expand to a gasoline vehicle in addition to a diesel vehicle and OBD regulation range will include PN in addition to particulate matter. The particle size of particulate matter may be measured by measuring particulate matter and PN. However, resistance change of the conventional particulate matter sensor depends only on the total amount of deposited particulate matter, so it is impossible to measure PN.

In the meantime, exhaust gas contains fine metal particles induced from lubricating oil, and the like. As shown in the figure, when metal particles having high electrical conductivity adhere to the electrode, the difference in the resistivity value (p) with particulate matter of which the main component is carbon greatly affects the measurements of particulate matter.

Therefore, it is necessary to develop a particulate matter sensor that is capable of correction to temperature difference without being affected by metal particles in exhaust gas.

Accordingly, the present disclosure has been made keeping in mind the above problems occurring in the related art, and the present disclosure is intended to propose an exhaust gas particulate matter (PM) sensor detecting the amount and the size of particulate matter by measuring a resistance value (R) or electrical conductance (G=1/R), wherein the effect of the temperature of exhaust gas and the effect of deposited particulate matter are corrected and the exhaust gas PM sensor is equipped with a heater electrode for regeneration that does not require a temperature sensor.

In order to accomplish the above object, according to an aspect of the present invention, there is provided a particulate matter (PM) sensor that is provided on an exhaust line through which exhaust gas from a vehicle passes and is provided with an electrode formed to detect PM, the PM sensor including: a first insulating layer; a temperature compensation electrode placed under the first insulating layer; a PM detection electrode placed in parallel with the temperature compensation electrode; a second insulating layer placed under the PM detection electrode and the temperature compensation electrode; a heater electrode placed under the second insulating layer; a third insulating layer placed under the heater electrode; a semiconducting layer placed between the second insulating layer and sensing electrodes of the PM detection electrode and the temperature compensation electrode.

The PM detection electrode may be composed of a sensing electrode sensing PM and of an external electrode electrically connecting the sensing electrode to outside, and the external electrode of the PM detection electrode may not be exposed to exhaust gas by the first insulating layer, and only the sensing electrode of the PM detection electrode may be exposed to the exhaust gas.

The semiconducting layer, particulate matter, and the PM detection electrode and the temperature compensation electrode may be in order of decreasing magnitude in resistivity. The respective resistivity of PM detection electrode and the temperature compensation electrode is much the same.

The sensing electrode may be formed between the external electrodes spaced apart from each other by a predetermined distance.

A resistance value or electrical conductance changed by particulate matter deposited in the semiconducting layer may be distinguished in multiple stages.

There is provided a particulate matter (PM) sensor that is provided on an exhaust line through which exhaust gas from a vehicle passes and is provided with an electrode formed to detect PM, the PM sensor including: a first insulating layer; a PM detection electrode placed under the first insulating layer; a second insulating layer placed under the PM detection electrode; a temperature compensation electrode placed under the second insulating layer; a third insulating layer placed under the temperature compensation electrode; a heater electrode placed under the third insulating layer; a fourth insulating layer placed under the heater electrode; and a semiconducting layer placed between a sensing electrode of the PM detection electrode and the second insulating layer, and between a sensing electrode of the temperature compensation electrode and the third insulating layer.

Regeneration temperature can be measured by using the temperature compensation electrode through a regeneration step where a heater is used.

There is provided a particulate matter (PM) sensor that is provided on an exhaust line through which exhaust gas from a vehicle passes and is provided with an electrode formed to detect PM, the PM sensor including: a first insulating layer; a PM detection electrode placed under the first insulating layer; a second insulating layer placed under the PM detection electrode; a heater electrode placed under the second insulating layer; a third insulating layer placed under the heater electrode; a temperature compensation electrode placed under the third insulating layer; a fourth insulating layer placed under the temperature compensation electrode; and a semiconducting layer placed between a sensing electrode of the PM detection electrode and the second insulating layer, and between the third insulating layer and a sensing electrode of the temperature compensation electrode.

In an exhaust gas particulate matter (PM) sensor that is provided on an exhaust line through which exhaust gas from a vehicle passes and is provided with an electrode formed to detect PM according to the present invention, a semiconducting layer, particulate matter, and sensing electrodes of a PM detection electrode and a temperature compensation electrode may be in order of decreasing magnitude in resistivity; the sensing electrode may be formed between external electrodes spaced apart from each other; a semiconducting layer may be included; the PM detection electrode and the temperature compensation electrode may be placed between a first insulating layer and a second insulating layer; and a heater electrode may be placed between the second insulating layer and a third insulating layer, whereby temperature correction may be possible by a resistance value R1 measured at the PM detection electrode and a resistance value R2 measured at the temperature compensation electrode, Regeneration temperature can be measured by using the temperature compensation electrode through a regeneration step where a heater is used.

Further, the semiconducting layer, particulate matter, and the sensing electrodes of the PM detection electrode and the temperature compensation electrode may be in order of decreasing magnitude in resistivity; the sensing electrode may be formed between the external electrodes spaced apart from each other; the semiconducting layer may be included; the PM detection electrode may be placed between the first insulating layer and the second insulating layer; the temperature compensation electrode may be placed between the second insulating layer and the third insulating layer; and the heater electrode may be placed between the third insulating layer and the fourth insulating layer, whereby temperature correction may be possible by a resistance value R1 measured at the PM detection electrode and a resistance value R2 measured at the temperature compensation electrode, and regeneration temperature can be measured by using the temperature compensation electrode through a regeneration step where a heater is used.

In this case, the semiconducting layer may be placed between the sensing electrode of the PM detection electrode and the second insulating layer, and between the sensing electrode of the temperature compensation electrode and the third insulating layer.

Further, the semiconducting layer, particulate matter, and the sensing electrodes of the PM detection electrode and the temperature compensation electrode may be in order of decreasing magnitude in resistivity; the sensing electrode may be formed between the external electrodes spaced apart from each other; the semiconducting layer may be included; the PM detection electrode may be placed between the first insulating layer and the second insulating layer; the heater electrode may be placed between the second insulating layer and the third insulating layer; and the temperature compensation electrode may be placed between the third insulating layer and the fourth insulating layer, whereby temperature correction may be possible by a resistance value R1 measured at the PM detection electrode and a resistance value R2 measured at the temperature compensation electrode, and regeneration temperature can be measured by using the temperature compensation electrode through a regeneration step where a heater is used.

In this case, the semiconducting layer may be placed between the sensing electrode of the PM detection electrode and the second insulating layer, and between the third insulating layer and the sensing electrode of the temperature compensation electrode.

According to an embodiment of the present invention, the exhaust gas PM sensor performs compensation for the temperature of the exhaust gas PM sensor, deposited particulate matter, and the temperature thereof, whereby more accurate PM sensing and regeneration and temperature measured by a heater are possible without a temperature sensor.

When the resistance value R1 is measured at the PM detection electrode and the resistance value R2 is measured at the temperature compensation electrode spaced apart by a predetermined distance from the PM detection electrode having the same area as the temperature compensation electrode, temperature correction of the PM detection electrode is performed by a ratio between R1 and R2 or a difference between R1 and R2. The PM detection electrode and the temperature compensation electrode are the same in material and area. More specifically, the sensing electrode of the PM detection electrode and the sensing electrode of the temperature compensation electrode are the same in material and area. The PM detection electrode is exposed to exhaust gas and is thus covered with particulate matter, and the temperature compensation electrode is not directly exposed to exhaust gas by the insulating layer. Therefore, it is possible to correct temperature difference that occurs due to the influence of particulate matter by a resistance difference between R1 and R2 or a resistance ratio between R1 and R2 under the same conditions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a structure of a conventional exhaust gas particulate matter sensor;

FIG. 2 is a diagram illustrating a structure of an exhaust gas particulate matter sensor according to the present invention;

FIG. 3 is a diagram illustrating stages at which PM is deposited in an exhaust gas particulate matter sensor according to the present invention;

FIG. 4 is a graph illustrating change in resistance and electrical conductance for each stage at which PM is deposited according to the present invention;

FIG. 5 is a diagram illustrating a length (L_{O}) of a sensing electrode and PM particle size (1) according to the present invention;

FIG. 6 is a diagram illustrating a shape of a sensing electrode and an external electrode that are capable of correction to a temperature of a PM sensor and deposited particulate matter according to the present invention;

FIG. 7 is a diagram illustrating an example of temperature sensing and heater regeneration structure of a PM sensor according to the present invention;

FIG. 8 is a diagram illustrating another example of temperature sensing and heater regeneration structure of a PM sensor according to the present invention;

FIG. 9 is a diagram illustrating still another example of temperature sensing and heater regeneration structure of a PM sensor according to the present invention; and

FIG. 10 is a diagram illustrating still another example of temperature sensing and heater regeneration structure of a PM sensor according to the present invention.

### DESCRIPTION OF THE PREFERRED EMBODIMENTS

Embodiments described below are provided so that those skilled in the art can easily understand the technical spirit of the present invention, and thus the present invention is not limited thereto. In addition, the matters described in the attached drawings may be different from those actually implemented by schematized drawings to easily describe embodiments of the present invention.

It will be understood that when an element is referred to as being coupled or connected to another element, it can be directly coupled or connected to the other element or intervening elements may be present therebetween.

The term “connection” as used herein means a direct connection or an indirect connection between a member and another member, and may refer to all physical connections such as adhesion, attachment, fastening, bonding, coupling, and the like.

Also, the expressions such as “first”, “second”, etc. are used only to distinguish between plural configurations, and do not limit the order or other specifications between configurations.

As used herein, the singular forms “a”, “an”, and “the” are intended to include the plural forms as well, unless the context clearly indicates otherwise. It is to be understood that terms such as “including”, “having”, etc. are intended to indicate the existence of the features, numbers, steps, actions, elements, parts, or combinations thereof disclosed in the specification, and are intended to include the possibility that one or more other features, numbers, steps, actions, elements, parts, or combinations thereof may be added.

Hereinafter, an exhaust gas particulate matter sensor according to an embodiment of the present invention will be described in detail with reference to the accompanying drawings.

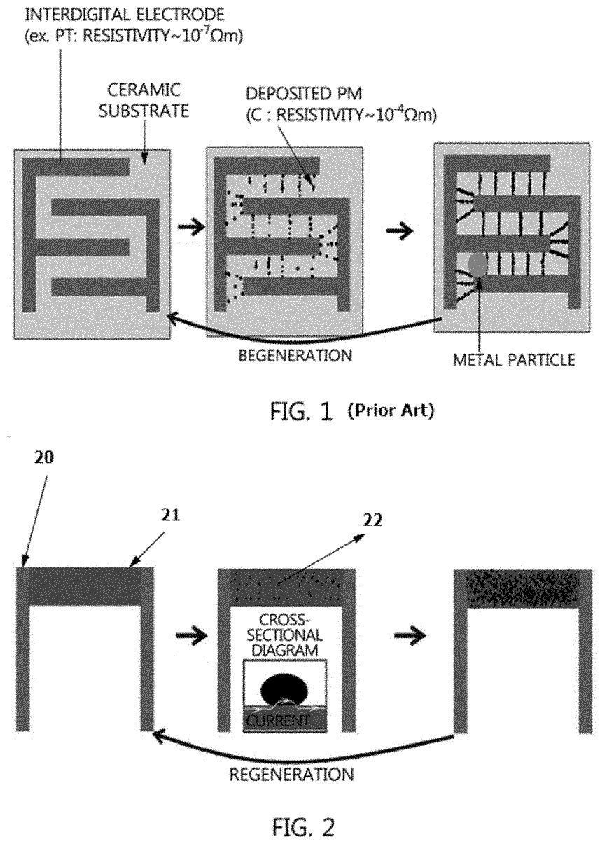

FIG. 1 is a diagram illustrating a structure of a conventional exhaust gas particulate matter sensor. FIG. 2 is a diagram illustrating a structure of an exhaust gas particulate matter sensor according to the present invention.

In FIG. 1, a PM detection electrode of the conventional PM sensor is formed of a pair of interlocking interdigital electrodes (IDEs) wherein patterned electrodes on a ceramic substrate are spaced apart from each other by a predetermined distance. As the material of the interdigital electrode, platinum having resistivity of 10⁻⁷ Ωm may be used.

In FIG. 1, the PM detection electrode is composed of a sensing electrode and an external electrode. The PM detection electrode is intended to measure resistance change caused by deposition of particulate matter in the sensing electrode that is located between the external electrodes, and has a disadvantage in that the resistance change is affected not only by particulate matter generated by incomplete combustion and but also by metal particles contained in exhaust gas. That is, the exhaust gas includes fine metal particles contained in lubricating oil, and the like, which may affect resistance change. When a metal particle causes an electric current to be applied to the electrode, electrical conductance rises rapidly, resulting in the fatal impact on the function of the PM sensor measuring the resistance change.

In FIG. 2, according to the present invention, in order to reduce the influence of metal particles contained in the exhaust gas, a sensing electrode 21 that has greater resistivity (namely, low electrical conductivity (σ=1/p)) than that of an external electrode and particulate matter 22 is placed between external electrodes 20. As the material of the external electrode, platinum having resistivity of 10⁻⁷ Ωm may be used. As the material of the sensing electrode, SiC, which is a semiconducting material, having resistivity of 10⁻³ Ωm may be used.

That is, as particulate matter is deposited in the sensing electrode, the current that has been flowing through the sensing electrode flows through particulate matter having low resistivity (namely, relatively high electrical conductivity than that of the sensing electrode), so the total resistance is reduced. The resistance change at this time is measured to find out the amount of deposited particulate matter.

The present invention has a difference to the conventional one in that the distance between the sensing electrodes can be larger. Because the present invention makes it possible to measure the signals from the PM deposition between the sensing electrodes. And this difference results in lower effect of metal particle in the exhaust gas.

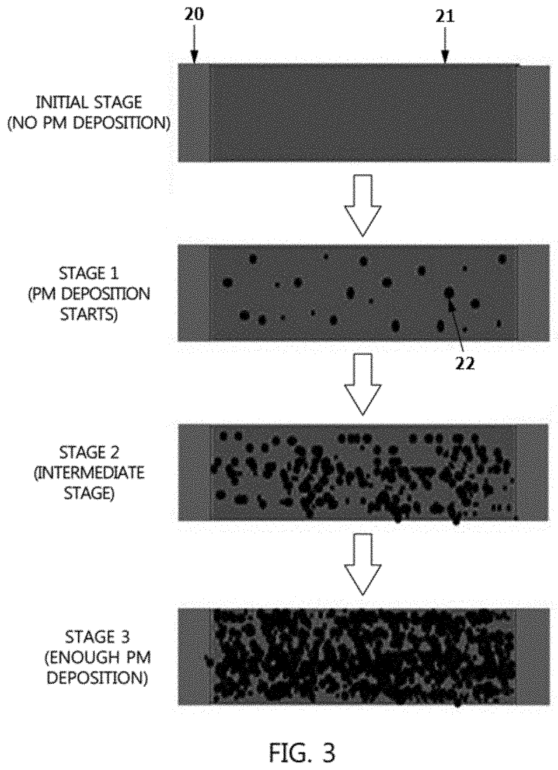

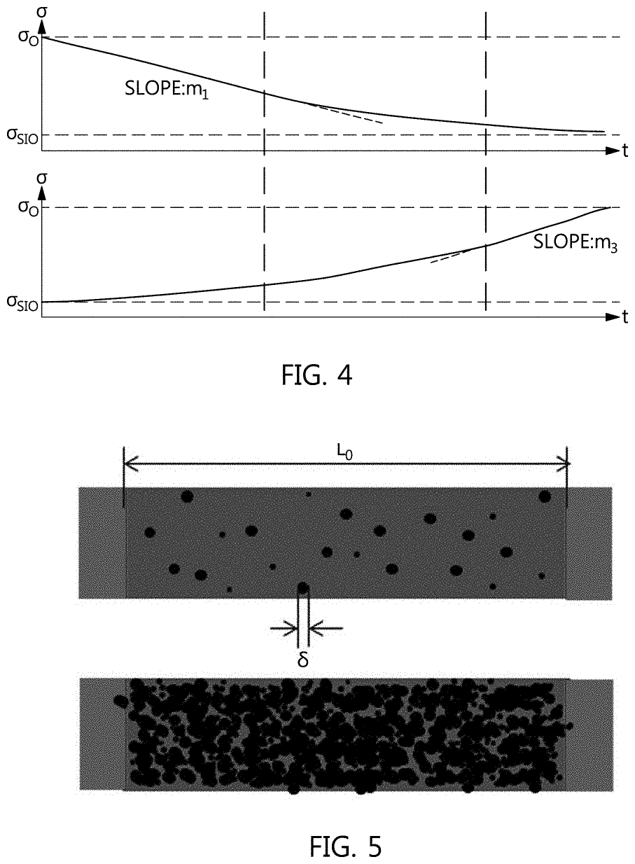

FIG. 3 is a diagram illustrating stages at which PM 22 is deposited in an exhaust gas particulate matter sensor according to the present invention. The initial stage is that there is no particulate matter deposited in the sensing electrode 21 located between the external electrodes 20. Stage 1 where deposition of the particulate matter starts and Stage 2 where deposition proceeds are followed by Stage 3 where particulate matter is sufficiently deposited. A characteristic for distinguishing the stages is described with change in resistance or electrical conductance shown in FIG. 4.

After the deposition of particulate matter starts, the change in total resistance is related to the amount of particulate matter deposited in the sensing electrode as well as to the size of particulate matter, which may be represented by ˜V₀/lⁿ. The total amount (hereinafter, the total amount means volume) of the particulate matter deposited in the sensing electrode is denoted by Vo, the diameter of the deposited particulate matter is denoted by l, and a constant according to the shape of the particulate matter is denoted by n.

The change in total resistance at Stage 3 where the particulate matter is sufficiently deposited is related only to the total amount of the deposited particulate matter. Therefore, the total amount (Vo) of the deposited particulate matter may be measured from the resistance value at Stage 3, and the number of particulate matter may be calculated by offsetting VO from the resistance value at Stage 1. After Stage 3, when a predetermined amount or more of particulate matter is deposited, continuous monitoring is possible through a regeneration step.

This is represented by an equation as follows.

The resistance (R) at the sensing electrode located between the external electrodes is represented by 1/R=1/R_{SiC}+1/R_{C}, wherein the resistance R_{SiC} is caused by SiC which is the semiconducting substrate and the resistance R_{C} is caused by the particulate matter.

The total resistance (R) at Stage 1 is represented by R=ρ_{SiC}/A_{SiC}(L₀−V₀/l²)=ρ_{SiC}L₀/A_{SiC}−ρ_{SiC}V₀/A_{SiC}l², wherein ρ_{SiC}, A_{SiC}, L₀, V₀, and l denote resistivity of the sensing electrode, the cross-sectional area of the sensing electrode, the length of the sensing electrode, the total volume of the deposited particulate matter, and the diameter of the deposited particulate matter, respectively.

Here, ρ_{SiC}L₀/A_{SiC} is R₀, −ρ_{SiC}V₀/A_{SiC}l² is ΔR_{PM}, and R=R₀+ΔR_{PM} is obtained.

In the meantime, V₀ is V₀=v₀·t. The total amount of the particulate matter deposited in the sensing electrode is denoted by V₀, and the amount of particulate matter deposited per unit of time is denoted by v₀, and time is denoted by t. When applying this, at Stage 1, R=ρ_{SiC}/A_{SiC} (L₀−V₀/l²)=ρ_{SiC}L₀/A_{SiC}−ρ_{SiC}V₀/A_{SiC}l²=ρ_{SiC}L₀/A_{SiC}−(ρ_{SiC}v₀/A_{SiC}l²)·t is a linear equation that increases linearly with respect to time t and the slope m1 is −(ρ_{SiC}v₀/A_{SiC} l²).

The total resistance (R) at Stage 3 is dependent on the resistance (R_{C}) caused by the particulate matter.

That is, R˜R_{C}=p_{C} L₀/A_{C}=p_{C} L₀²/V₀ is obtained. The resistivity and the cross-sectional area of the deposited particulate matter are denoted by p_{C} and A_{C}, respectively. The length of the sensing electrode and the total volume of the deposited particulate matter are denoted by L₀ and V₀, respectively.

From this, electrical conductance G=V₀/(p_{C} L₀²), which is the inverse of the resistance, is obtained. When applying V₀=v₀·t, electrical conductance G=(v₀/p_{C} L₀²)·t is obtained. That is, electrical conductance is represented by a linear equation having the slope m3=(v₀/p_{C} L₀²) with respect to time.

In the meantime, the amount v₀ of particulate matter deposited per unit of time is proportional to the amount (V_{PM}) of particulate matter in the exhaust gas. From this, v₀=α·V_{PM} is represented, and V_{PM}=(p_{C} L₀²/α)·m3 is obtained.

In the meantime, at Stage 1, from m1=−(p_{SiC}v₀/A_{SiC} l²), m3=(v₀/p_{C} L₀²), and l²=−(p_{SiC}v₀/A_{SiC}) m3/m1, the size of the particulate matter is determined.

In the meantime, the size 1 of particulate matter depends mainly on the type of fuel, such as gasoline or diesel, and the characteristic of the engine, such as direct injection or turbocharging, so the size I does not change much over time and is regarded as a constant (l₀). From this, the amount of particulate matter at Stage 1 is determined by V_{PM}=−(A_{SiC}l₀²/p_{SiC} α)·m1.

In the meantime, FIG. 4 is a diagram illustrating change in resistance and electrical conductance for each stage at which PM is deposited according to the present invention. FIG. 4 shows characteristics of Stage 1 and Stage 3. That is, Stage 1 has a characteristic that the resistance linearly decreases over time as particulate matter is deposited. Stage 3 has a characteristic that electrical conductance linearly increases over time as particulate matter is deposited. That is, the slope m1 at Stage 1 has a negative value and the slope m3 at Stage 3 has a positive value.

From the slope m3=v₀/(p_{C}L₀²) of electrical conductance measured at Stage 3, α is obtained.

From these values, V_{PM}=(p_{C} L₀²/α)·m3, which is the amount of particulate matter in the exhaust gas, is calculated. From m1=−p_{SiC} v₀/(A_{SiC} l²) measured at Stage 1, the size 1 of particulate matter, l²=−(p_{SiC}_{ₚ}_{C}L₀²/A_{SiC}) m3/m1, is calculated.

FIG. 5 is a diagram illustrating a length (L_{O}) of a sensing electrode and PM particle size (1) according to the present invention.

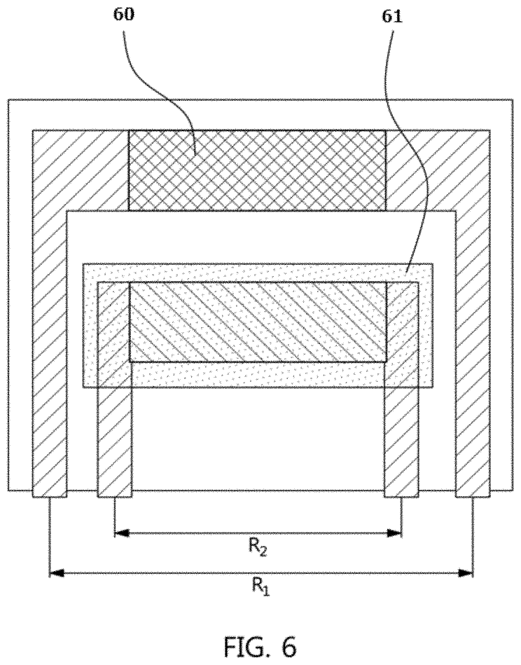

FIG. 6 is a diagram illustrating a shape of a sensing electrode and an external electrode that are capable of correction to a temperature of a PM sensor and deposited particulate matter according to the present invention.

Compared to FIG. 2 wherein the semiconducting substrate is used as the sensing electrode, FIG. 6 shows a concept that in addition to the external electrode with the semiconducting substrate which is used as the sensing electrode, another external electrode for temperature correction is provided with a non-conductive coating on a semiconducting substrate. FIG. 6 shows the structure of a sensing electrode-external electrode (a PM detection electrode) and semiconducting substrate 60 without temperature correction and in addition to the PM detection electrode, and also shows the structure (located at the inner bottom of the PM detection electrode in FIG. 6) of a sensing electrode-external electrode 61 (hereinafter, referred to as a temperature compensation electrode) with a non-conductive coating on a semiconducting substrate. In this specification, temperature compensation and temperature correction have substantially the same meaning. The term “a temperature compensation electrode” is used as the name of the electrode structure, but otherwise the term “temperature correction” is used.

A sensing electrode using a semiconducting substrate is described above with reference to FIGS. 2 to 5, which yields a measurement value (hereinafter, referred to as R1) without temperature correction.

A sensing electrode with a non-conductive coating, which is located between external electrodes for temperature correction yields a measurement value (hereinafter, referred to as R2) for temperature correction. The difference in resistance values caused by temperature correction is represented by ΔR=R1−R2, and the ratio of resistance values caused by temperature correction is represented by γ=R1/R2.

R1=R_{O}+ΔR_{T}+ΔR_{PM} is obtained, and R2=R_{O}+ΔR_{T} is obtained. The resistance before temperature change before particulate matter is deposited is denoted by R_{O}. The resistance change caused only by temperature change is denoted by ΔR_{T}. The resistance change caused only by deposition of particulate matter is denoted by ΔR_{PM}, and is proportional to the difference between the resistivity of the semiconducting substrate and the resistivity caused by deposition of the particulate matter and to the amount of the deposited particulate matter. From this, ΔR_{PM}=β′ (p_{SiC}−p_{C})·M_{PM} is represented. The resistivity of particulate matter is negligible compared to the resistivity of a sensing electrode substrate, so ΔR_{PM}=β′·p_{SiC}·M_{PM} is represented. Here, β′ is the proportionality constant that is equal to the ratio of the resistance change caused by deposition of particulate matter to the product of the amount of the deposited particulate matter and the difference in resistivity between the semiconducting substrate and particulate matter. When using R_{SiC}=p_{SiC}·L₀/A_{SiC}, ΔR_{PM}=β·R_{SiC}·M_{PM} is represented. Here, β=β′·A_{SiC}/L₀ is the proportionality constant that is equal to the ratio of the resistance change caused by deposition of particulate matter to the product of the resistance of the semiconducting substrate and the amount of the deposited particulate matter. The resistance before particulate matter is deposited is denoted by R_{SiC} which is equal to R2. Therefore, ΔR_{PM}=β·R2·M_{PM} is represented. At Stage 1, ΔR_{PM}=−p_{SiC}V₀/(A_{SiC}l²) is represented. When using M_{PM}=V₀·δ_{PM}, β=1/(δ_{PM}·l³) is obtained. Here, density of particulate matter is denoted by δ_{PM}.

From this, ΔR=R1−R2=ΔR_{PM} denotes the difference in resistance value caused by the deposited particulate matter, and γ=R1/R2 is linearly proportional to the mass of particulate matter deposited at 1+−·M_{PM}.

In the meantime, SiC refers to semiconducting ceramic (SC), and SiC is an example thereof.

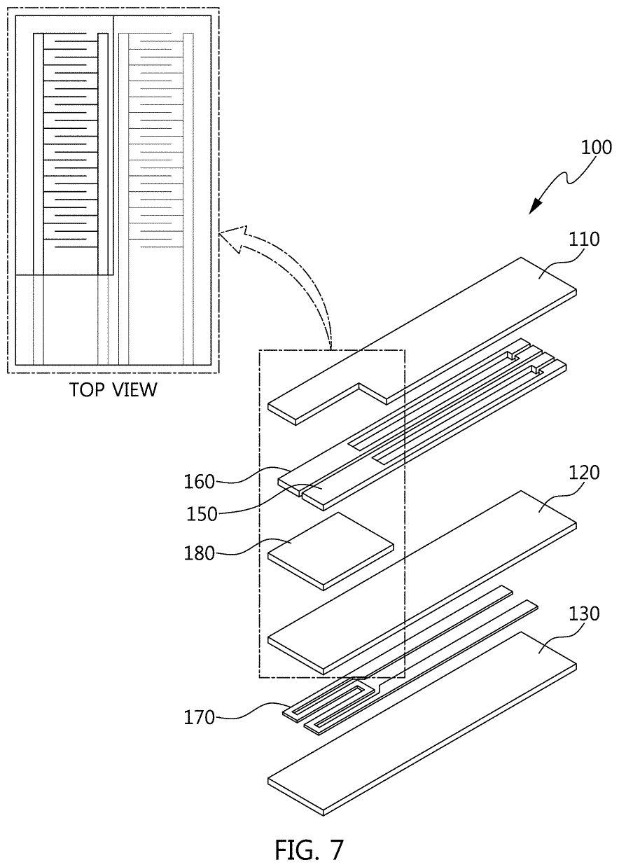

FIG. 7 shows a particulate matter (PM) sensor 100 that is provided on an exhaust line through which exhaust gas from a vehicle passes, the PM sensor being provided with an electrode formed to detect PM. The PM sensor 100 includes: a first insulating layer 110; a temperature compensation electrode 160 placed under the first insulating layer 110; a PM detection electrode 150 spaced apart from the temperature compensation electrode by a predetermined distance; a second insulating layer 120 placed under the PM detection electrode 150 and the temperature compensation electrode 160; a heater electrode 170 placed under the second insulating layer 120; and a third insulating layer 130 placed under the heater electrode 170.

FIG. 7 shows an example of positions of the PM detection electrode 150 without temperature correction and the temperature compensation electrode 160 for temperature correction, wherein two electrodes are spaced apart from each other by a predetermined distance along the length of the PM sensor and are positioned side by side in the leftward-rightward direction on the same plane with the same length as the PM sensor, under the first insulating layer 110. Regarding the PM detection electrode 150 and the temperature compensation electrode 160, the whole surface may be supported by the second insulating layer 120 placed below. Further, only the sensing electrodes, which are parts of the PM detection electrode 150 and the temperature compensation electrode 160 may not be directly supported by the second insulating layer 120, and the semiconducting layer 180 may be placed therebetween. The semiconducting layer 180 is a coating layer and is supported by the external electrode of the PM detection electrode 150 and of the temperature compensation electrode 160, and by the second insulating layer 120. The effect of thickness is neglected.

The first insulating layer is placed on the PM detection electrode 150 and the temperature compensation electrode 160, but does not cover the entire PM detection electrode 150 and the entire temperature compensation electrode 160. As shown in FIG. 7, the sensing electrode of the PM detection electrode 150 is not covered with the first insulating layer 110. Conversely, the entire temperature compensation electrode 160 is covered with the first insulating layer 110.

That is, except for the sensing electrode of the PM detection electrode 150, the external electrodes of the PM detection electrode 150 and of the temperature compensation electrode 160 and the temperature compensation electrode 160 may be covered with the first insulating layer 110 for support.

The temperature compensation electrode 160 is not directly exposed to exhaust gas by the first insulating layer 110, and the sensing electrode of the PM detection electrode 150 needs to be directly exposed to exhaust gas, so the first insulating layer 110 is not placed on the corresponding part.

Unlike the temperature compensation electrode 160, the first insulating layer is not placed on the sensing electrode of the PM detection electrode 150 and the sensing electrode is formed to be directly exposed to exhaust gas.

The heater electrode 170 for PM regeneration is placed under the second insulating layer 120, and the third insulating layer 130 is placed under the heater electrode 170. That is, in order to thermally remove PM deposited in the PM detection electrode 150, the heater electrode 170 is placed below the bottom of the PM detection electrode 150 with the second insulating layer 120 in between.

When deposition of PM is performed in the PM detection electrode 150, the PM detection electrode 150 needs to perform self-regeneration. Here, the heater serving as a heat source is placed below the bottom of the PM detection electrode 150. The heater and the PM detection electrode 150 are unable to be in direct contact with each other, so the insulating layer that is electrically insulated and capable of heat transfer is necessary.

In the meantime, regeneration temperature measurement is required for controlling the heater and is performed by the temperature compensation electrode 160. That is, the temperature compensation electrode 160 measures the temperature of the second insulating layer 120 for on/off control of the heater. Since the second insulating layer 120 contains a semiconducting material (for example, SiC), the relationship between the temperature and the resistance change is set in advance as a relational expression or a table. The heater voltage is controlled in such a manner as to maintain the resistance corresponding to the temperature at which PM oxidizes, so heater control is possible without a temperature sensor.

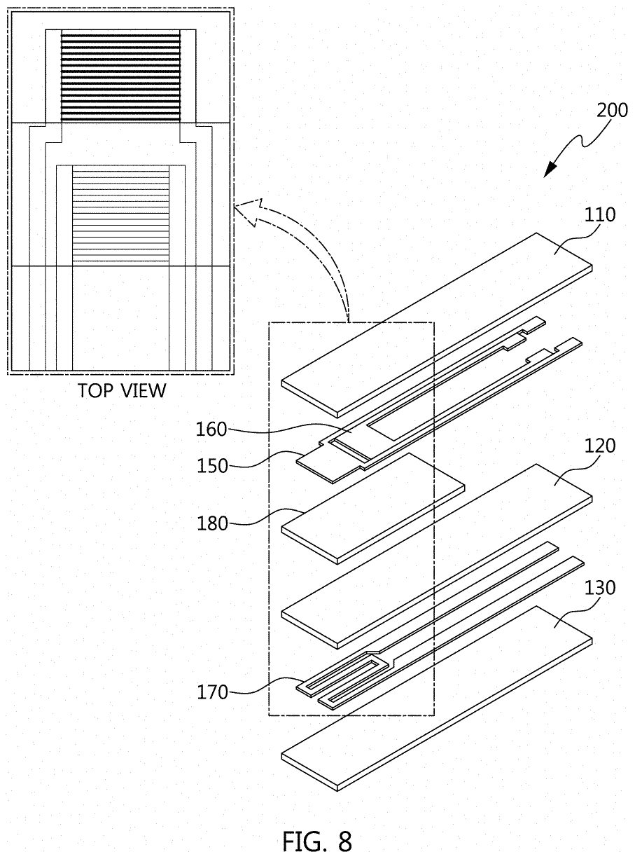

In the PM sensor 100 shown in FIG. 7, the PM detection electrode 150 and the temperature compensation electrode 160 are placed side by side in the leftward-rightward direction with respect to the longitudinal direction on the same place. In the PM sensor 200 shown in FIG. 8, the PM detection electrode 150 and the temperature compensation electrode 160 which have the same width are placed side by side in the inward-outward direction with respect to the longitudinal direction of the PM sensor on the same plane. Here, the sensing electrode of the PM detection electrode 150 is placed further outward with respect to the longitudinal direction of the PM sensor in comparison with the sensing electrode of the temperature compensation electrode 160. The sensing electrode of the temperature compensation electrode 160 is placed inward.

Similarly to the example shown in FIG. 7, in the second example shown in FIG. 8 the sensing electrodes of the PM detection electrode 150 and the temperature compensation electrode 160 are supported by the second insulating layer 120 via the semiconducting layer. That is, the semiconducting layer is provided for coating between the second insulating layer and the sensing electrodes of the PM detection electrode 150 and of the temperature compensation electrode 160. In contrast, the external electrodes of the PM detection electrode 150 and of the temperature compensation electrode 160 are supported by the second insulating layer 120.

The heater electrode 170 is placed between the second insulating layer 120 and the third insulating layer 130 and is placed at a point where the PM detection electrode 150 is able to be heated.

In the arrangement structure shown in FIG. 7, the positions of the respective sensing electrodes of the PM detection electrode 150 and the temperature compensation electrode 160 are advantageous for extension in the longitudinal direction. In the arrangement structure shown in FIG. 8, the positions of the respective sensing electrodes of the PM detection electrode 150 and the temperature compensation electrode 160 are advantageous for extension in the traverse direction. Two types of multiple sensors may be provided in such a manner as to make the sensing electrodes of the PM detection electrode 150 and of the temperature compensation electrode 160 advantageous for extension in the longitudinal direction or the traverse direction.

The second insulating layer 120 is placed below the PM detection electrode 150 and the temperature compensation electrode 160.

The sensing electrodes of the PM detection electrode 150 and of the temperature compensation electrode 160 are not in direct contact with the second insulating layer 120 for support. The coating layer of a semiconducting material, namely, the semiconducting layer 180 is placed between the sensing electrode and the second insulating layer 120. Since the thickness of the semiconducting layer is negligible, the external electrodes of the PM detection electrode 150 and of the temperature compensation electrode 160 are in direct contact with the second insulating layer 120 for support.

The entire temperature compensation electrode 160 is not directly exposed to exhaust gas by the first insulating layer 110, and the sensing electrode of the PM detection electrode 150 needs to be directly exposed to exhaust gas, so the first insulating layer 110 is not placed on the sensing electrode of the PM detection electrode 150. Therefore, the first insulating layer 110 is shorter than the second insulating layer 120 by the length of the sensing electrode of the PM detection electrode 150 which is exposed to exhaust gas.

Similarly to the temperature compensation electrode 160, the external electrodes of the PM detection electrode 150 and of the temperature compensation electrode 160 are covered with the first insulating layer 110. That is, except for the sensing electrode of the PM detection electrode 150, the external electrodes of the PM detection electrode 150 and of the temperature compensation electrode 160 and the temperature compensation electrode 160 are covered with the first insulating layer 110.

In the meantime, when the PM detection electrode 150 and the temperature compensation electrode 160 are placed on the same plane, two electric circuits are close to each other. The fact that the PM detection electrode 150 is close to the temperature compensation electrode 160 on the same plane may be disadvantageous in an exhaust gas environment where particulate matter which is a conductive material is present.

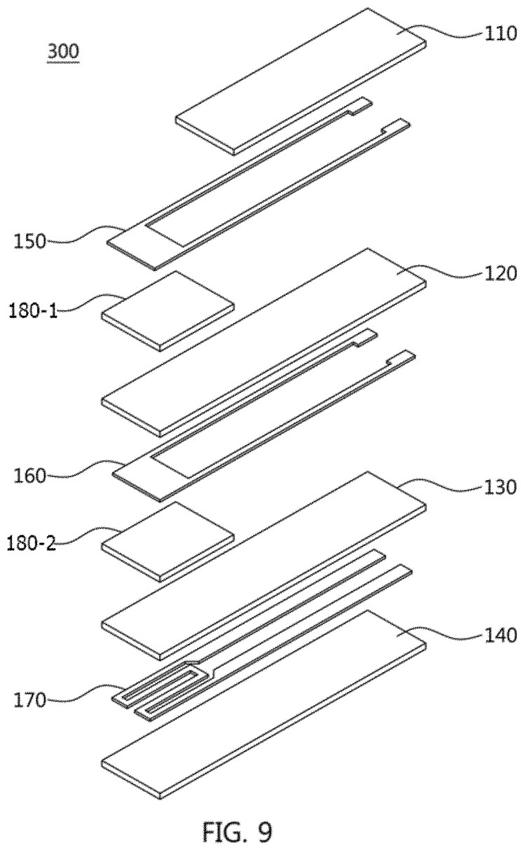

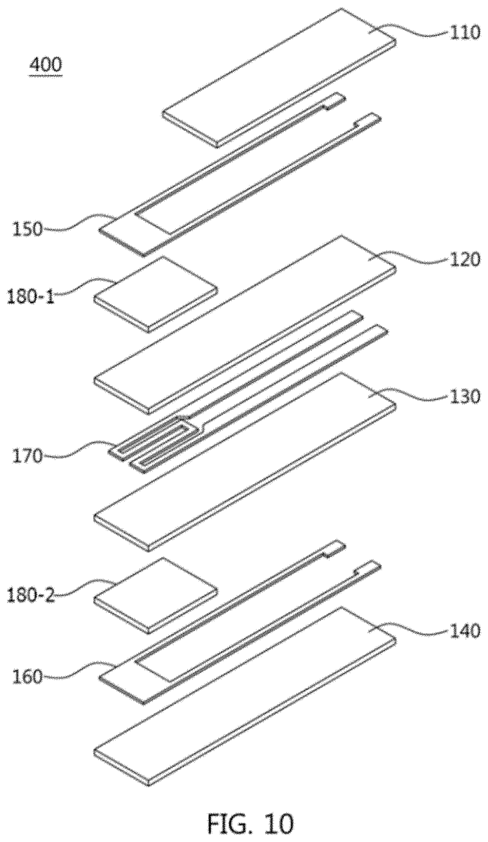

Thus, FIG. 9 shows a structure in which the electric circuits are placed within different insulating layers.

FIG. 9 shows a particulate matter (PM) sensor 300 that is provided on an exhaust line through which exhaust gas from a vehicle passes, the PM sensor being provided with an electrode formed to detect PM. The PM sensor 400 includes: a first insulating layer 110; a PM detection electrode 150 placed under the first insulating layer 110; a second insulating layer 120 placed under the PM detection electrode 150; a temperature compensation electrode 160 placed under the second insulating layer 120; a third insulating layer 130 placed under the temperature compensation electrode 160; a heater electrode 170 placed under the third insulating layer 130; and a fourth insulating layer 140 placed under the heater electrode 170.

That is, the structure has the first insulating layer 110, the PM detection electrode 150, the second insulating layer 120, the temperature compensation electrode 160, the third insulating layer 130, the heater electrode 170, and the fourth insulating layer 140 in that order.

The sensing electrode of the PM detection electrode 150 is not covered with the first insulating layer thereon to be directly exposed to exhaust gas, and only the external electrode of the PM detection electrode 150 is covered with the first insulating layer 110 for support. Therefore, the first insulating layer 110 is shorter than the second insulating layer 120.

In FIG. 9, a first and second semiconducting layer 180-1 and 180-2 may be placed between the sensing electrode of the PM detection electrode 150 and the second insulating layer 120, and between the sensing electrode of the temperature compensation electrode 160 and the third insulating layer 130 respectively.

This is intended to more accurately measure a temperature rise that is caused by the heater electrode 170 because the temperature compensation electrode 160 is close to the heater electrode 170.

The temperature of the sensing electrode of the PM detection electrode 150 needs to be increased to 700° C. or more so that PM deposited in the sensing electrode of the PM detection electrode oxidizes. In practice, the heater needs to be heated to a higher temperature. Here, the risk of excessive temperature rise that possibly occurs may be blocked by the third insulating layer 130 and the second semiconducting layer 180-2.

FIG. 10 shows a particulate matter (PM) sensor 400 that is provided on an exhaust line through which exhaust gas from a vehicle passes, the PM sensor being provided with an electrode formed to detect PM. The PM sensor 300 includes: a first insulating layer 110; an external electrode of a PM detection electrode 150 placed under the first insulating layer 110; a second insulating layer 120 placed under the PM detection electrode 150; a heater electrode 170 placed under the second insulating layer 120; a third insulating layer 130 placed under the heater electrode 170; a temperature compensation electrode 160 placed under the third insulating layer 130; and a fourth insulating layer 140 placed under the temperature compensation electrode 160.

That is, the structure has the first insulating layer 110, the PM detection electrode 150, the second insulating layer 120, the heater electrode 170, the third insulating layer 130, the temperature compensation electrode 160, and the fourth insulating layer 140 in that order.

The second insulating layer 120 is placed under the PM detection electrode 150.

The sensing electrode of the PM detection electrode 150 may be supported via the semiconducting layer 180 without being in direct contact with the second insulating layer 120.

The temperature compensation electrode 160 is not directly exposed to exhaust gas, but the sensing electrode of the PM detection electrode 150 needs to be directly exposed to exhaust gas, so there is no first insulating layer 110 thereon.

Except the sensing electrode of the PM detection electrode 150, only the external electrode of the PM detection electrode 150 is covered with the first insulating layer 110 for support. Thus, unlike the temperature compensation electrode 160, the insulating layer is not placed on the sensing electrode of the PM detection electrode 150 and the sensing electrode is formed to be directly exposed to exhaust gas.

In FIG. 10, the semiconducting layer 180 may be placed between the sensing electrode of the PM detection electrode 150 and the second insulating layer 120, and between the third insulating layer 130 and the temperature compensation electrode 160.

Compared with the case where the PM detection electrode 150 and the temperature compensation electrode 160 are placed side by side on the same place, the number of insulating layers is increased, so electrical stability is obtained.

It is desired that the first insulating layer 110 and the fourth insulating layer 140 are provided at symmetrical points with respect to exhaust gas flow.

It will be understood by those skilled in the art that the present invention can be embodied in other specific forms without changing the technical idea or essential characteristics of the present invention. Therefore, the above-described embodiments are the most preferred embodiments selected among various embodiments in order to help those skilled in the art to understand the present invention, and the technical idea of the present invention is not limited to the above-described embodiments. It is noted that various modifications, additions, and substitutions are possible and, equivalents thereof are also possible, without departing from the technical idea of the present invention. The scope of the present invention is characterized by the appended claims rather than the detailed description described above, and it should be construed that all alterations or modifications derived from the meaning and scope of the appended claims and the equivalents thereof fall within the scope of the present invention. It is also to be understood that all terms or words used in the specification and claims are defined on the basis of the principle that the inventor is allowed to define terms appropriately for the best explanation. Thus, the terms or words should not be interpreted as being limited merely to typical meanings or dictionary definitions. Further, the order of described configurations in the above-described process is not necessary to be performed in a time series, and even though the performance order of configurations and steps is changed as long as the gist of the present invention is satisfied, these processes are included in the scope of the present invention.

What is claimed is:

1. An exhaust gas particulate matter (PM) sensor for a vehicle, the sensor comprising:
a first insulating layer;
a temperature compensation electrode placed under the first insulating layer;
a PM detection electrode placed with the temperature compensation electrode side by side on the same plane;
a second insulating layer placed under the PM detection electrode and the temperature compensation electrode;
a heater electrode placed under the second insulating layer; and
a third insulating layer placed under the heater electrode,
wherein external electrodes of the PM detection electrode and of the temperature compensation electrode and the temperature compensation electrode are not exposed to exhaust gas by the first insulating layer, and a sensing electrode of the PM detection electrode is exposed to the exhaust gas.

2. The sensor of claim 1, wherein a sensing electrode of the temperature compensation electrode and the sensing electrode of the PM detection electrode are placed with the same length side by side in a leftward-rightward direction along a longitudinal direction of the PM sensor.

3. The sensor of claim 1, wherein a sensing electrode of the temperature compensation electrode and the sensing electrode of the PM detection electrode are placed with the same width side by side in an inward-outward direction along a longitudinal direction of the PM sensor, and the sensing electrode of the PM detection electrode is placed further outward in comparison with the sensing electrode of the temperature compensation electrode.

4. The sensor of claim 2, further comprising:
a semiconducting layer placed between the second insulating layer and the sensing electrodes of the PM detection electrode and the temperature compensation electrode,
wherein the semiconducting layer, particulate matter, and the sensing electrodes of the PM detection electrode and the temperature compensation electrode are in order of decreasing magnitude in resistivity, and the sensing electrode of the temperature compensation electrode and the sensing electrode of the PM detection electrode are the same in area and material, and
a resistance value R1 of the PM detection electrode and a resistance value R2 of the temperature compensation electrode are measured, and temperature compensation of the PM detection electrode is performed using a difference between the R1 and the R2 or a ratio between the R1 and the R2.

5. The sensor of claim 3, further comprising:
a semiconducting layer placed between the second insulating layer and the sensing electrodes of the PM detection electrode and the temperature compensation electrode,
wherein the semiconducting layer, particulate matter, and the sensing electrodes of the PM detection electrode and the temperature compensation electrode are in order of decreasing magnitude in resistivity, and the sensing electrode of the temperature compensation electrode and the sensing electrode of the PM detection electrode are the same in area and material, and
a resistance value R1 of the PM detection electrode and a resistance value R2 of the temperature compensation electrode are measured, and temperature compensation of the PM detection electrode is performed using a difference between the R1 and the R2 or a ratio between the R1 and the R2.

6. An exhaust gas particulate matter (PM) sensor for a vehicle, the sensor comprising:
a first insulating layer;
a PM detection electrode placed under the first insulating layer;
a second insulating layer placed under the PM detection electrode;
a temperature compensation electrode placed under the second insulating layer;
a third insulating layer placed under the temperature compensation electrode;
a heater electrode placed under the third insulating layer; and
a fourth insulating layer placed under the heater electrode,
wherein external electrodes of the PM detection electrode and of the temperature compensation electrode are not exposed to exhaust gas by the first insulating layer, and only a sensing electrode of the PM detection electrode is exposed to the exhaust gas.

7. The sensor of claim 6, further comprising:
a semiconducting layer placed between the sensing electrode of the PM detection electrode and the second insulating layer, and between a sensing electrode of the temperature compensation electrode and the third insulating layer,
wherein the semiconducting layer, particulate matter, and the sensing electrodes of the PM detection electrode and the temperature compensation electrode are in order of decreasing magnitude in resistivity, and the sensing electrode of the temperature compensation electrode and the sensing electrode of the PM detection electrode are the same in area and material, and
a resistance value R1 of the PM detection electrode and a resistance value R2 of the temperature compensation electrode are measured, and temperature compensation of the PM detection electrode is performed using a difference between the R1 and the R2 or a ratio between the R1 and the R2.

8. An exhaust gas particulate matter (PM) sensor for a vehicle, the sensor comprising:
a first insulating layer;
a PM detection electrode placed under the first insulating layer;
a second insulating layer placed under the PM detection electrode;
a heater electrode placed under the second insulating layer;
a third insulating layer placed under the heater electrode;
a temperature compensation electrode placed under the third insulating layer; and
a fourth insulating layer placed under the temperature compensation electrode,
wherein external electrodes of the PM detection electrode and of the temperature compensation electrode are not exposed to exhaust gas by the first insulating layer, and only a sensing electrode of the PM detection electrode is exposed to the exhaust gas.

9. The sensor of claim 8, further comprising:
a semiconducting layer placed between the sensing electrode of the PM detection electrode and the second insulating layer, and between the third insulating layer and a sensing electrode of the temperature compensation electrode,
wherein the semiconducting layer, particulate matter, and the sensing electrodes of the PM detection electrode and the temperature compensation electrode are in order of decreasing magnitude in resistivity, and the sensing electrode of the temperature compensation electrode and the sensing electrode of the PM detection electrode are the same in area and material, and
a resistance value R1 of the PM detection electrode and a resistance value R2 of the temperature compensation electrode are measured, and temperature compensation of the PM detection electrode is performed using a difference between the R1 and the R2 or a ratio between the R1 and the R2.
